(19) United States
(12) Patent Application Publication
(10) Pub. No.: US 2018/0235363 A1
(43) Pub. Date: Aug. 23, 2018

(54) HEIGHT ADJUSTABLE SYSTEM FOR PORTABLE COMPUTING DEVICES

(71) Applicant: ERGOTRON, INC., Saint Paul, MN (US)

(72) Inventors: Michael Patrick MURPHY, Scottsdale, AZ (US); Joseph Chase RAMIREZ, Tucson, AZ (US); Pete SEGAR, St. Paul, MN (US); Ryan Loree DEFUSCO, Mesa, AZ (US); George Charles Willard RUNGER, Chandler, AZ (US); Saeb Salih ASAMARAI, Columbia Heights, MN (US); Robert William FLUHRER, Prior Lake, MN (US)

(21) Appl. No.: 15/748,002

(22) PCT Filed: Jul. 1, 2016
(86) PCT No.: PCT/US16/40724

§ 371 Date: Jan. 26, 2018

Related U.S. Application Data
(60) Provisional application No. 62/197,326, filed on Jul. 27, 2015.

(51) Int. Cl. A47B 23/04; F16M 11/26; F16M 11/04; F16M 13/02

(52) U.S. Cl. CPC A47B 23/043; F16M 11/26; F16M 11/046; F16M 2200/08; A47B 2023/049; F16M 2200/028; F16M 13/02

(57) ABSTRACT

A height adjustable system for supporting a portable computing device can include a telescoping frame including a movable portion configured to couple to the work surface and a fixed portion. The movable portion can include a first side, a second side, an upper bridge extending between the first side of the movable portion and the second side of the movable portion. The fixed portion can include a first side, a second side, a lower bridge extending between the first side of the fixed portion and the second side of the fixed portion, the first side of the fixed portion configured to receive at least a portion of the first side of the movable portion, the second side of the fixed portion configured to receive at least a portion of the second side of the movable portion, and a base configured to couple to and support the telescoping frame.

### CLAIM OF PRIORITY

This patent application claims the benefit of U.S. Provisional Patent Application Ser. No. 62/197,326, titled “HEIGHT ADJUSTABLE SYSTEM FOR PORTABLE COMPUTING DEVICES,” by Michael Patrick Murphy et al., and filed on Jul. 27, 2015 (Attorney Docket No. 5983.282PRV), which is hereby incorporated by reference herein in its entirety.

### TECHNICAL FIELD

This document pertains generally, but not by way of limitation, to an assembly for providing a height adjustable work surface.

### BACKGROUND

Portable electronic computers, e.g., laptop computers and notebook computers, have gained in popularity due to their decreasing size and weight. A computer user often finds the portability of a portable computer useful, for example, when traveling, or working from both home and the office. Unfortunately, the design features of portable computers that allow them to be portable also make them ergonomically awkward to use, especially for long periods of time. Traditional stands have been provided to allow for some position adjustability, but these stands typically only allow a user to set the position of the notebook in a relatively few pre-set positions and are generally difficult to adjust.

### OVERVIEW

In an example, this disclosure is directed to a height adjustable system for supporting a portable computing device. The system can include a work surface and a telescoping frame. The telescoping frame can include a movable portion configured to couple to the work surface and fixed portion. The movable portion can include a first side, a second side; and an upper bridge extending between the first side of the movable portion and the second side of the movable portion. The fixed portion can include a first side, a second side, a lower bridge extending between the first side of the fixed portion and the second side of the fixed portion, the first side of the fixed portion configured to receive at least a portion of the first side of the movable portion, the second side of the fixed portion configured to receive at least a portion of the second side of the movable portion. The system can include a base configured to couple to and support the telescoping frame, a locking mechanism configured to releasably fix the position of the movable portion relative to the fixed portion, and a release mechanism coupled to and configured to control the locking mechanism.

In another example, this disclosure is directed to a height adjustable system for supporting a portable computing device. The system can include a work surface and a telescoping frame. The telescoping frame can include a movable portion configured to couple to the work surface and a fixed portion. The movable portion can include a first side, a second side, and an upper bridge extending between the first side of the movable portion and the second side of the movable portion. The fixed portion can include a first side, a second side, and a lower bridge extending between the first side of the fixed portion and the second side of the fixed portion, the lower bridge including a first latching mechanism, the first side of the fixed portion configured to receive at least a portion of the first side of the movable portion, the second side of the fixed portion configured to receive at least a portion of the second side of the movable portion. The system can include a base configured to couple to and support the telescoping frame, a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base, a locking mechanism configured to releasably fix the position of the movable portion relative to the fixed portion, and a release mechanism coupled to and configured to control the locking mechanism.

In another example, this disclosure is directed to a height adjustable system for supporting a portable computing device. The system can include a work surface including a work surface attachment bracket and a telescoping frame. The telescoping frame can include a movable portion configured to couple to the work surface and a fixed portion. The movable portion can include a first side, a second side, an upper bridge extending between the first side of the movable portion and the second side of the movable portion, and an upper brace extending between the first side of the movable portion and the second side of the movable portion, the upper brace defining a configured to receive the work surface attachment bracket. The fixed portion can include a first side, a second side, a lower bridge extending between the first side of the fixed portion and the second side of the fixed portion, the lower bridge including a first latching mechanism, the first side of the fixed portion configured to receive at least a portion of the first side of the movable portion, the second side of the fixed portion configured to receive at least a portion of the second side of the movable portion. The system further includes a base configured to couple to and support the telescoping frame, a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base, a locking mechanism configured to releasably fix the position of the movable portion relative to the fixed portion, and a release mechanism coupled to and configured to control the locking mechanism.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a front view of an example height adjustable system for supporting a portable computing device, in accordance with at least one example of this disclosure.

FIG. 2 is a rear perspective view of the example height adjustable system of FIG. 1, in accordance with at least one example of this disclosure.

FIG. 3 is a front perspective view of the telescoping frame of the height adjustable system of FIG. 1, in accordance with at least one example of this disclosure.

FIG. 4 is a front perspective view of the telescoping frame of the height adjustable system of FIG. 1, in accordance with at least one example of this disclosure.

FIG. 5 is a front perspective view of an example locking mechanism that can be used to lock a telescoping frame, in accordance with at least one example of this disclosure.

FIG. 6 is a front perspective view of an example upper bridge that can be used with various telescoping frames described in this disclosure, in accordance with at least one example of this disclosure.

FIG. 7 is a front perspective view of another telescoping frame described in this disclosure, in accordance with at least one example of this disclosure.

FIG. 8 is rear perspective view of the example telescoping frame of FIG. 7, shown in a compressed state, in accordance with at least one example of this disclosure.

FIG. 9 is rear perspective view of the example telescoping frame of FIG. 7, shown in an expanded state, in accordance with at least one example of this disclosure.

FIG. 10 is a front perspective view of a portion of another telescoping frame that can be used as part of a height adjustable system, in accordance with at least one example of this disclosure.

FIG. 11 is a front perspective view of the portion of the telescoping frame of FIG. 10 engaged to a work surface, in accordance with at least one example of this disclosure.

FIG. 12A is a top perspective view of an example work surface that can be used with the telescoping frame of FIGS. 10 and 11, in accordance with at least one example of this disclosure.

FIG. 12B is a bottom perspective view of the example work surface of FIG. 12A, in accordance with at least one example of this disclosure.

FIG. 12C is a side view of the example work surface 112 of FIG. 12A, in accordance with at least one example of this disclosure.

FIGS. 13A and 13B are perspective views depicting attachment of the work surface of FIGS. 12A-12C to a telescoping frame of a height adjustable system for supporting a portable computing device, in accordance with at least one example of this disclosure.

FIGS. 14A and 14B are front perspective views of an example height adjustable system for supporting a portable computing device, in accordance with at least one example of this disclosure.

FIG. 14C is a front view of the example height adjustable system of FIG. 14B, in accordance with at least one example of this disclosure.

FIGS. 15A-15C are various views of an example guide that can be used in a height adjustable system, in accordance with at least one example of this disclosure.

FIG. 16 is a front perspective view of an example side of a fixed portion of a telescoping frame, in accordance with at least one example of this disclosure.

FIG. 17 is a front perspective view of an example side of a moving portion of a telescoping frame, in accordance with at least one example of this disclosure.

FIG. 18 is a side cutaway view of an example side of a portion of a telescoping frame, in accordance with at least one example of this disclosure.

FIG. 19 is a side cutaway view of an example upper bridge of a telescoping frame, in accordance with at least one example of this disclosure.

FIG. 20 is a front perspective view of a lower portion of an example telescoping frame of a height adjustable system for supporting a portable computing device, in accordance with at least one example of this disclosure.

FIG. 21 is a rear perspective view of an example telescoping frame of a height adjustable system rotated relative to a base about a pivot hub, in accordance with at least one example of this disclosure.

FIG. 22 is a perspective view of an example base attachment bracket, in accordance with at least one example of this disclosure.

FIG. 23 is a perspective view of an example lower bridge housing coupled to the base attachment bracket of FIG. 22, in accordance with at least one example of this disclosure.

FIG. 24 is cross-sectional side view of an example cam follower mechanism of a telescoping frame.

FIG. 25 is cross-sectional side view of an example tilt latch mechanism of a telescoping frame, in accordance with at least one example of this disclosure.

FIG. 26 is a perspective view of an example tilt latch body, in accordance with at least one example of this disclosure.

FIG. 27 is a perspective view of an example height adjustable system for supporting a portable computing device, in a stored configuration, in accordance with at least one example of this disclosure.

FIG. 28A is a front view of another example of a height adjustable system for supporting a portable computing device, in an expanded configuration, in accordance with at least one example of this disclosure.

FIG. 28B is a front view of the system of FIG. 28A in a collapsed configuration, in accordance with at least one example of this disclosure.

FIG. 28C is a side view of the system of FIG. 28A, in accordance with at least one example of this disclosure.

FIG. 28D is a side view of the system of FIG. 28B, in accordance with at least one example of this disclosure.

### DETAILED DESCRIPTION

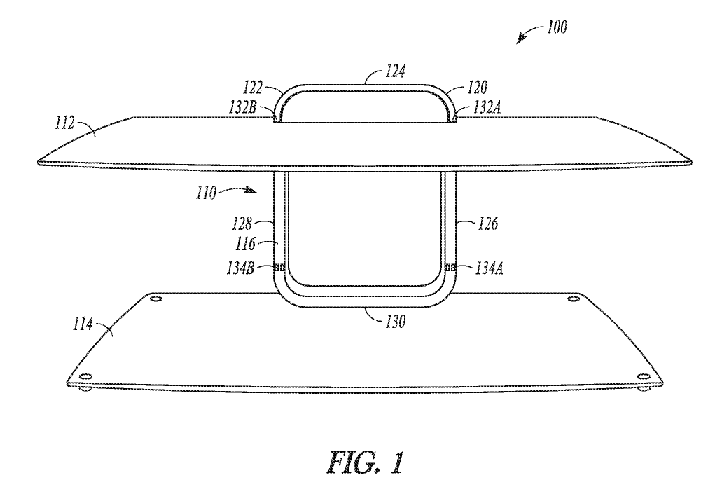

FIG. 1 is a front view of an example height adjustable system for supporting a portable computing device, in accordance with this disclosure. The system 100 of FIG. 1 can include a telescoping frame 110, a work surface 112 (also referred to in this disclosure as a “laptop tray” and can be configured to support a laptop), and a base 114 configured to couple to and support the telescoping frame 110. In some examples, the base 114 is configured to sit on a desk top or other work surface. The work surface 112 can be configured to support a portable electronic device, such as a laptop computer, phone, or tablet, or any other office items, such as documents, books, etc.

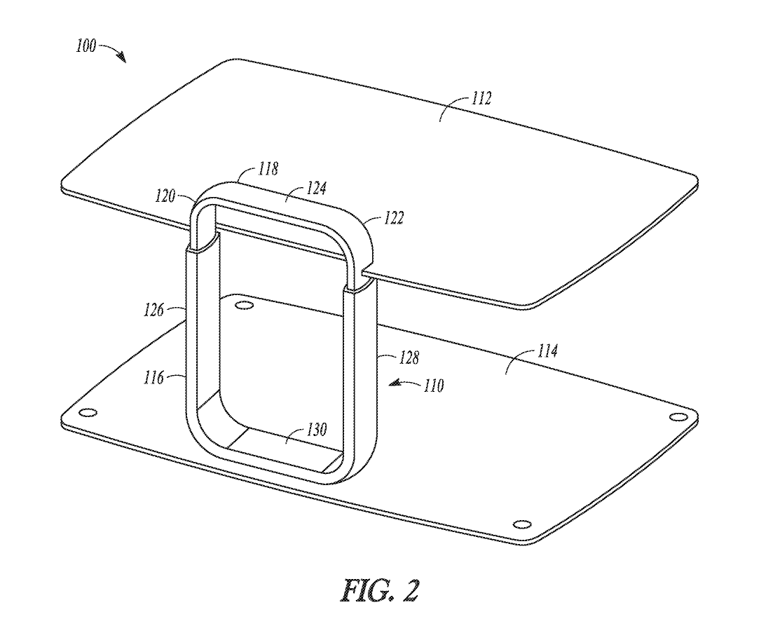

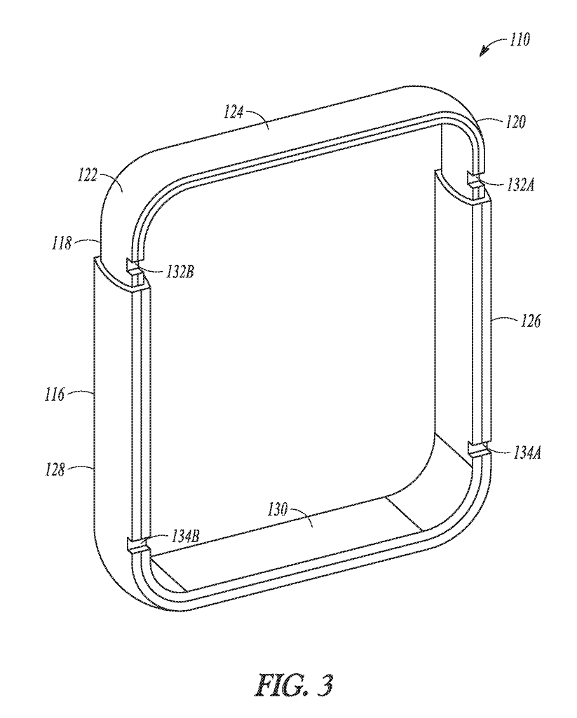

The telescoping frame 110 can include a fixed portion 116 and a movable portion 118 configured to couple to the work surface 112. The movable portion 118 can include a first side 120, a second side 122, and an upper bridge 124 extending between the first side of the movable portion and the second side of the movable portion. The upper bridge can also function as a handle to transport the system. In some example configurations, the movable portion 118 can include at least one interconnect configured to connect the work surface 112 to the frame 110 at a first height, as shown in more detail in FIGS. 2 and 3.

The fixed portion 116 can include a first side 126, a second side 128, and a lower bridge 130 extending between the first side of the fixed portion and the second side of the fixed portion. In the telescoping arrangement of FIG. 1, the first side 126 of the fixed portion 116 can be configured to receive at least a portion of the first side 120 of the movable portion 118, and the second side 128 of the fixed portion 116 can be configured to receive at least a portion of the second side 122 of the movable portion 118.

The telescoping frame 110 is adjustable to positions between a collapsed state and an expanded state. The telescoping frame 110 of FIG. 1 is depicted in a collapsed state, which can be used when a user is in a seated position, for example.

As mentioned above, the movable portion 118 can include at least one first interconnect configured to connect the work surface 112 to the frame 110 at a first height. In some examples, the first interconnect can include a first pair of hooks or notches defined by the movable portion and configured to receive the work surface at the first height. As seen in FIG. 1, the first side 120 of the movable portion 118 can include an interconnect 132A and the second side 122 of the movable portion 118 can include an interconnect 132B, where the interconnects 132A, 132B form the first pair of hooks.

In an example configuration, the fixed portion 116 can include at least one second interconnect configured to connect the work surface 112 to the frame 110 at a second height. In some examples, the second interconnect can include a second pair of hooks or notches defined by the fixed portion and configured to receive the work surface at the second height. As seen in FIG. 1, the first side 126 of the fixed portion 116 can include an interconnect 134A and the second side 128 of the fixed portion 116 can include an interconnect 134B, where the interconnects 134A, 134B form the second pair of hooks. The work surface 112 can be removably coupled with the frame 118. When in a seated position, the user can remove the work surface 112 from the interconnects 132A, 132B and position the work surface 112 in the interconnects 134A, 134B. In a standing position, the user can raise the movable portion 118 of the frame 110 to adjust the height of the work surface 112 with respect to the base 114.

FIG. 2 is a rear perspective view of the example height adjustable system of FIG. 1. The base 114 and the work surface 112 can be made of any known material including, but not limited to metal, glass, phenolic, wood, particle board, ABS, nylon. The telescoping frame 110 can be attached to the base 114. In some configurations, the frame 118 can be rotatingly coupled to the base 114. In other configurations, the frame 118 can be removably coupled to with the base 114.

FIG. 3 is a front perspective view of the telescoping frame of the height adjustable system of FIG. 1. As seen in FIG. 3, the first side 120 of the movable portion 118 can include an interconnect 132A and the second side 122 of the movable portion 118 can include an interconnect 132B, where the interconnects 132A, 132B form the first pair of hooks. In the example configuration of FIG. 3, the fixed portion 116 can include at least one second interconnect configured to connect the laptop tray (not depicted) to the frame 110 at a second height. As seen in FIG. 3, the first side 126 of the fixed portion 116 can include an interconnect 134A and the second side 128 of the fixed portion 116 can include an interconnect 134B, where the interconnects 134A, 134B form the second pair of hooks. The laptop tray can be removably coupled with the frame 118.

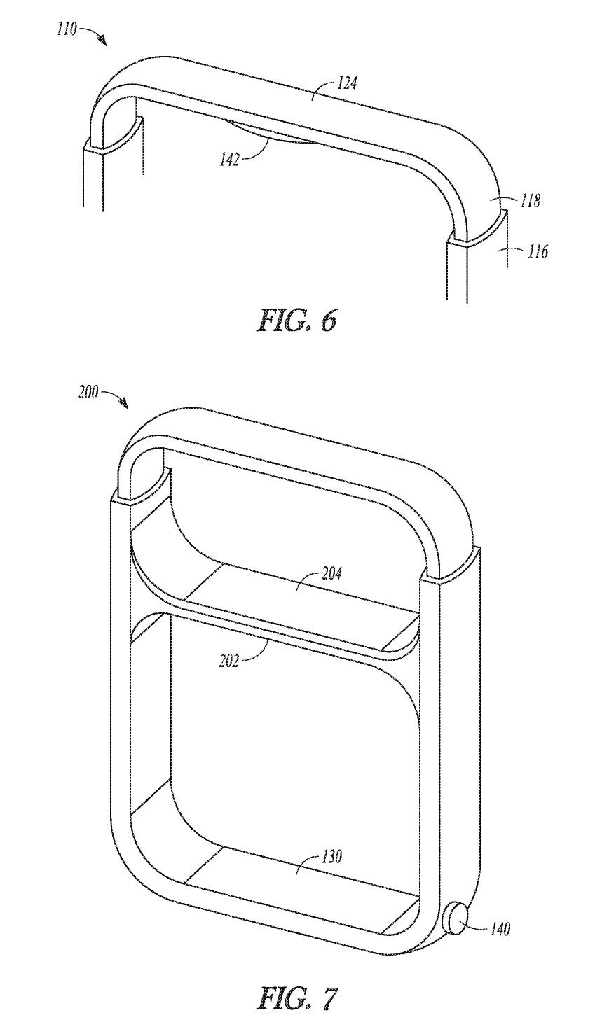

In some examples, the lower bridge 130 can include a tilt mechanism and be rotatingly coupled with the base, e.g., base 114 of FIG. 1. In an example configuration, the upper bridge 124 can include a handle and release bar, e.g., release button 142 of FIG. 6, for the height adjustment mechanism.

The telescoping frame 110 can be made up of various materials including, but not limited to, sheet metal, cast aluminum, extruded aluminum, or plastic such as ABS.

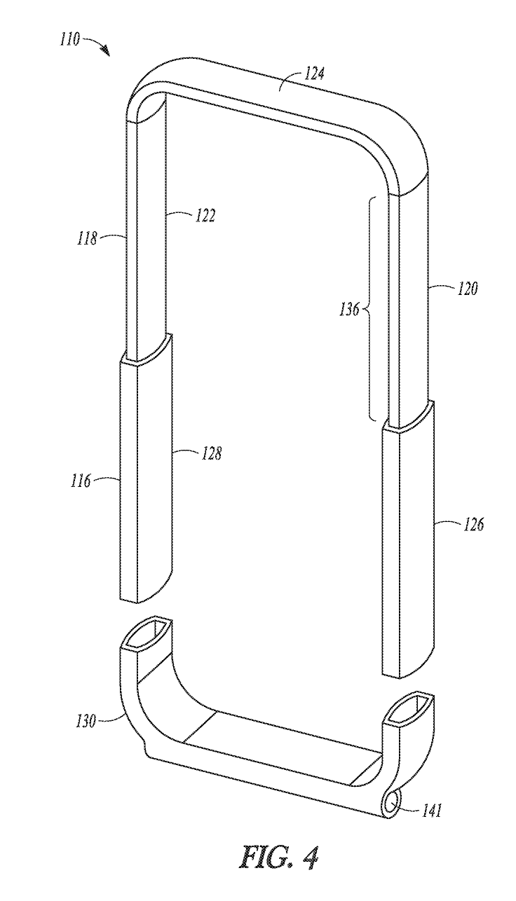

FIG. 4 is a front perspective view of the telescoping frame of the height adjustable system of FIG. 1. The movable portion 118 can be slidably engaged with the fixed portion 116. The fixed portion 116 can include a cross-section including, but not limited to, square, round, and oval shapes. Described in more detail below, the frame 110 can include a guide mechanism that can be built into the fixed portion 116 to allow the movable portion to slide smoothly between the contracted and expanded configurations of the telescoping frame.

As seen in FIG. 4, the movable portion 118 has moved upward relative to the fixed portion 116, thereby increasing the height of the telescoping frame 110 by an amount shown at 136. In some example configurations, described in detail below, the frame 110 can include a pivot 141 (also referred to as a pivot hub) that can allow the telescoping frame 110 to rotate relative to the base 114 (see FIG. 2) about the pivot 141. The first side 120 and second side 122 of the movable portion 118 are shown. The first side 126 and second side 128 of the fixed portion 116 are shown.

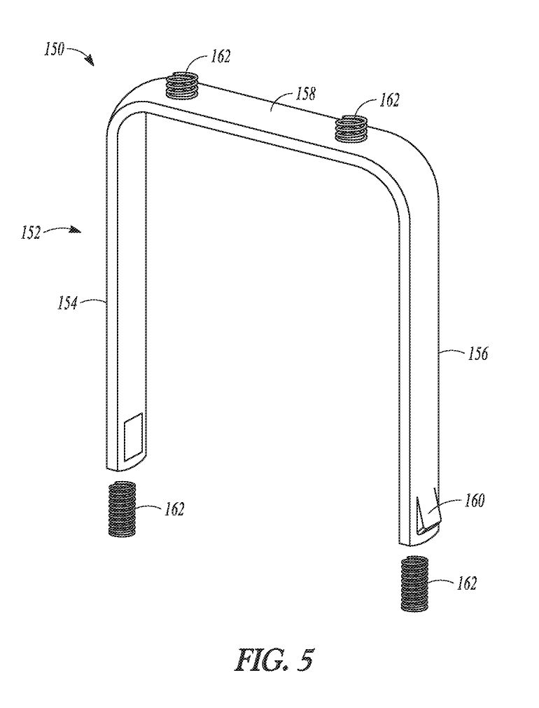

FIG. 5 is a front perspective view of an example locking mechanism 150 that can be used to lock a telescoping frame. The locking mechanism 150 can be built inside at least one side of the telescoping frame, e.g., telescoping frame 110 of FIG. 1. The locking mechanism 150 can releasably fix or lock the movable portion of the telescoping frame relative to the fixed portion of the telescoping frame at various expanded positions.

In some examples, the locking mechanism 150 can contain a lock bar 152. The lock bar 152 can be made of sheet metal or a bent rod, for example. The lock bar 152 can be made of a single bent component, or one or more sections can be made individually and then connected together in a final assembly. The first section 154 and the second section 156 can be located inside the first and second sides of the movable portion of the telescoping frame, respectively. The third section 158 of the lock bar can be located inside the upper bridge of the movable portion. In some examples, the lock bar 152 can include a locking emboss 160 on at least one of the first and second sections.

The lock bar 152 can be biased in a downwards direction relative to the upper bridge, e.g., by extension or compression springs 162. In the down position of the lock bar relative to the upper bridge, the locking emboss 160 can push a plunger (not shown) into apertures in a fixed portion of the telescoping frame, and lock the position of the movable portion. When a user pulls the lock bar 152 upwards, the locking emboss 160 can release the plunger and the movable portion of the telescoping frame is allowed to be adjusted.

FIG. 6 is a front perspective view of an example upper bridge that can be used with various telescoping frames described in this disclosure. In some example configurations, an upper bridge of a telescoping frame 110, e.g., the upper bridge 124 of FIG. 1, can include a release button 142 to allow height adjustments. The release button can be coupled to and configured to control the locking mechanism 150 (see FIG. 5).

In some examples, such as shown in FIG. 6, the release button 142 can be located at the underside of the upper bridge 124. The third section 158 of the lock bar (of FIG. 5) can be located inside the upper bridge. When the release button 142 is depressed, it can pull the lock bar. e.g., the lock bar 152 of FIG. 5, upwards relative to the upper bridge and unlock the height adjustment mechanism.

FIG. 7 is a front perspective view of another telescoping frame described in this disclosure. The telescoping frame 200 can include elements similar to the telescoping frame 110 described in FIGS. 1-6. For purposes of brevity, similar features will not be described again. In the example configuration shown in FIG. 7, the telescoping frame 200 can include a lower spanning brace 202 between the sides of the fixed portion and an upper spanning brace 204 between the sides of the movable portion of the telescoping frame to increase the structural strength of the frame 200.

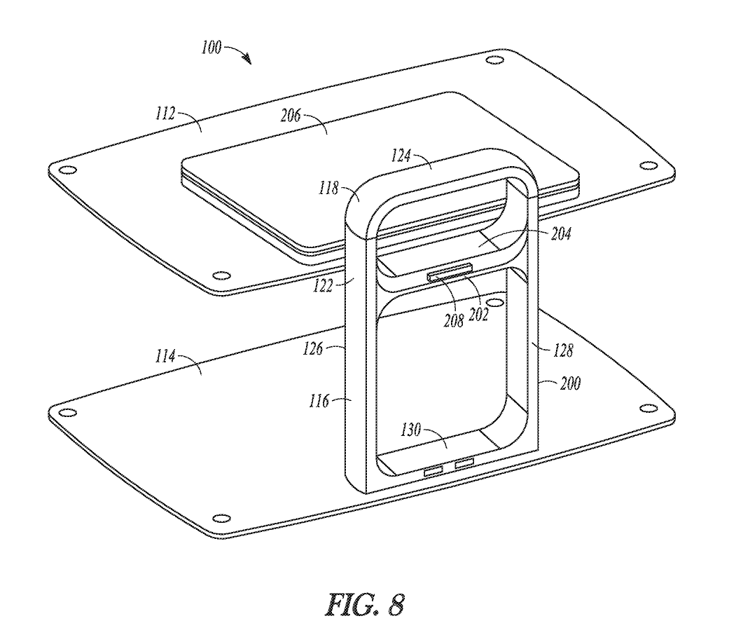

FIG. 8 is rear perspective view of the example telescoping frame of FIG. 7, shown in a compressed state. In the example configuration shown in FIG. 8, the telescoping frame 200 can include a lower spanning brace 202 between the first and second sides 126, 128 of the fixed portion 116 and an upper spanning brace 204 between the first and second sides 120, 122 of the movable portion 118 of the telescoping frame 200 to increase the strength of the frame 200. The height adjustable system 100 of FIG. 8 depicts the work surface 112 supporting a portable electronic device 206, e.g., laptop computer.

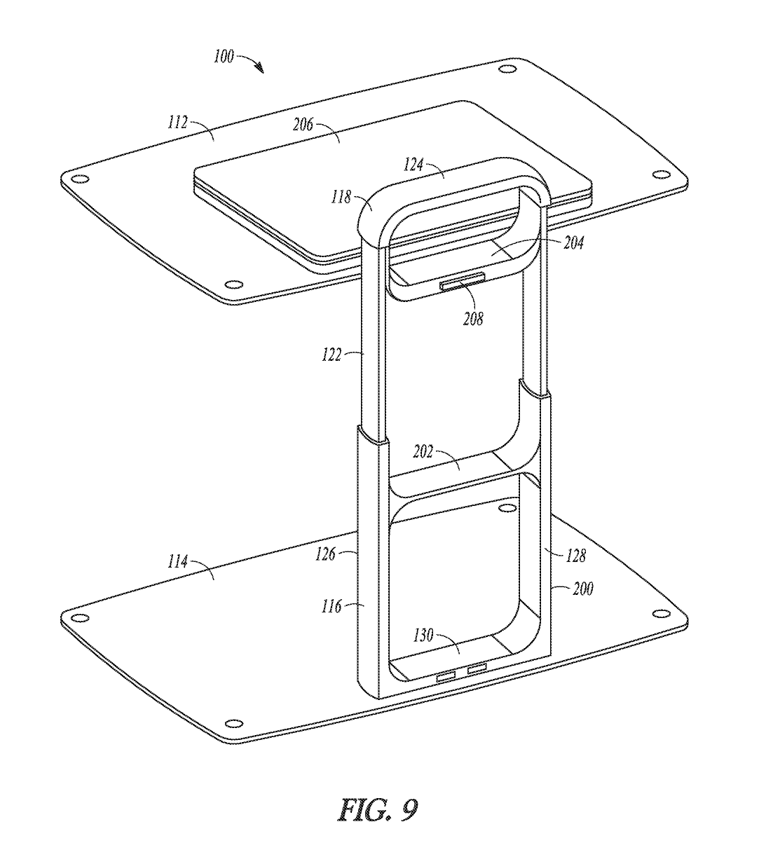

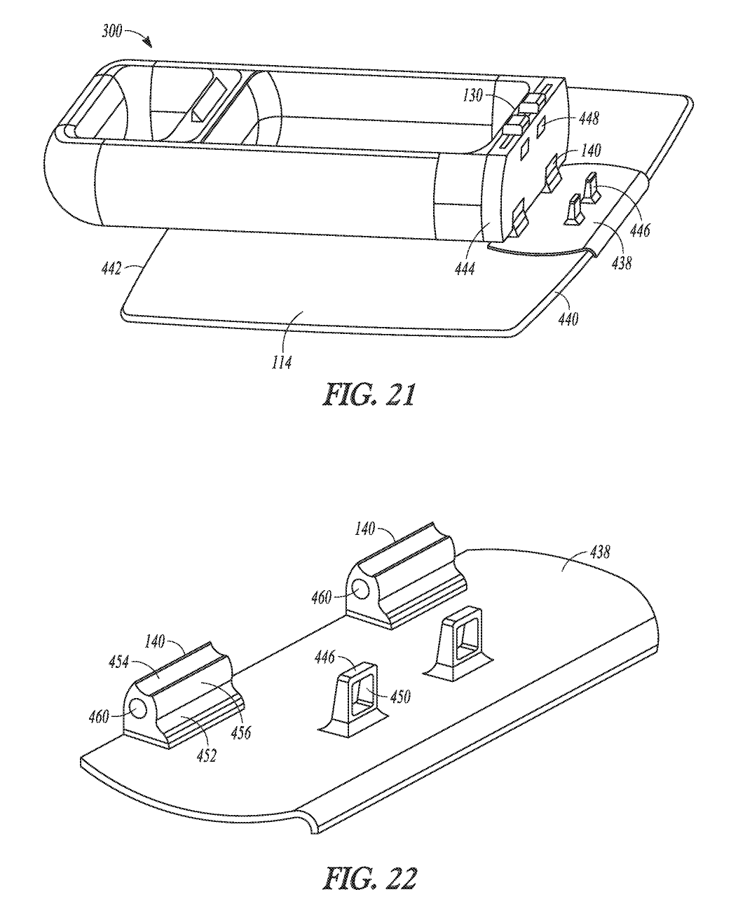

In some example configurations, the telescoping frame 200 can include a tab 208. In the example shown in FIGS. 8 and 9, the tab 208 can be attached to or formed integrally with a spanning brace, e.g., upper spanning brace 204. Similar to the telescoping frame 300 described below in FIG. 21, the frame 200 can be pivoted, e.g., about pivot 141 of FIG. 4, such that the frame 200 can be generally parallel to the base 114. Then, the work surface 112 can be attached to the tab 208 using a notch positioned on the underside of the work surface 112. In this manner, the system 100 can be placed into a folded, collapsed configuration.

FIG. 9 is rear perspective view of the example telescoping frame of FIG. 7, shown in an expanded state. In the example configuration shown in FIG. 9, the movable portion 118 of the telescoping frame 200 has been raised, thereby increasing the height of the work surface 112, e.g., laptop tray. The lower spanning brace 202 between the first and second sides 126, 128 of the fixed portion 116 and an upper spanning brace 204 between the first and second sides 120, 122 of the movable portion 118 of the telescoping frame 200 help stabilize and increase the strength of the frame 200.

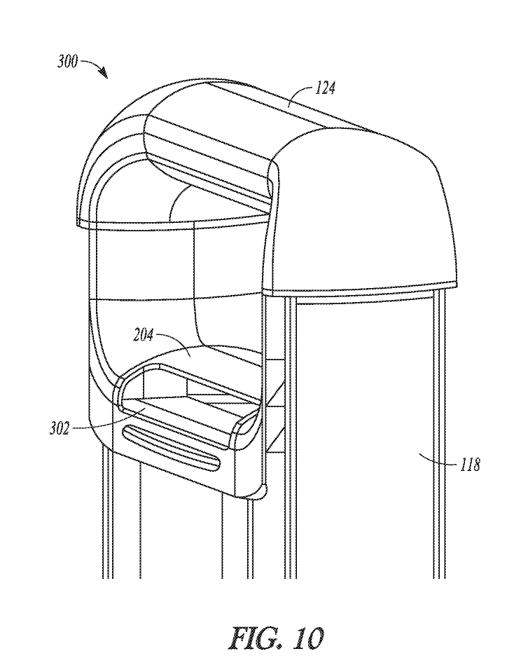

FIG. 10 is a front perspective view of a portion of another example of a telescoping frame 300 that can be used as part of a height adjustable system 100. Rather than include hooks or notches as interconnects to connect a laptop tray to the frame, as shown in FIGS. 1 and 2, the telescoping frame 300 of FIG. 10 can define at least one slot as an interconnect. More particularly, as shown in FIG. 10, a portion of the upper spanning brace 204 of the movable portion 118 can define a slot 302 that can be sized and shaped to receive a portion of a work surface, e.g., a laptop tray. For example, as shown in FIG. 11, the work surface 112, e.g., laptop tray, can include a bracket that fits into the slot 302.

FIG. 11 is a front perspective view of the portion of the telescoping frame 300 of FIG. 10 engaged to a work surface 112. As seen in FIG. 11, the work surface 112, e.g., laptop tray, can include an attachment bracket 304 extending from a rear edge 306 of the work surface 112 that fits into the slot 302 to removably secure the work surface 112 to the telescoping frame 300.

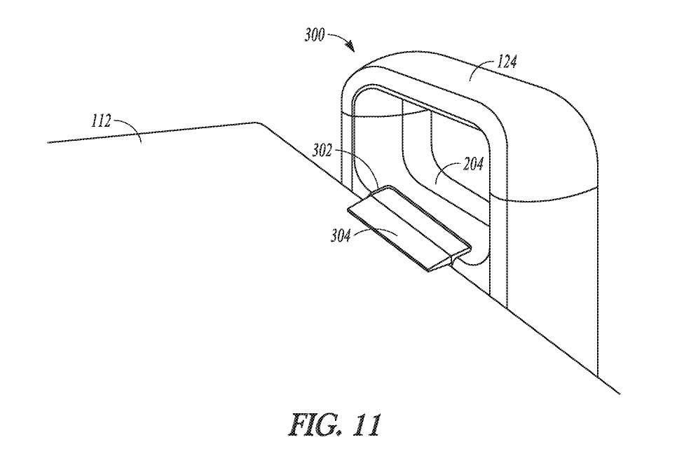

FIG. 12A is a top perspective view of an example work surface 112 that can be used with the telescoping frame 300 of FIGS. 10 and 11. In an example implementation, the top surface 308 of the work surface 112 can be smooth. As mentioned above, an attachment bracket 304 that can be sized and shaped to be received in the slot 302 of the telescoping frame 300 of FIGS. 10 and 11 can be fastened to the rear edge 306 of the work surface 112. In some configurations, the attachment bracket 304 can be formed as an integral part of the work surface 112.

FIG. 12B is a bottom perspective view of the example work surface 112 of FIG. 12A. In an example implementation, the bottom surface 310 of the work surface 112 can include one or more notches sized and shaped to mate with one or more respective tabs on the telescoping frame when the system is in a folded or stowed configuration. FIG. 12B depicts a first notch 312 and a second notch 314. The first notch 312 can be sized and shaped to mate with a tab, e.g., tab 208 shown in FIGS. 8 and 9.

FIG. 12C is a side view of the example work surface 112 of FIG. 12A. The attachment bracket 304 can be inserted into a slot on a telescoping frame, e.g., the slot 302 on the upper spanning brace 204 of the telescoping frame 300 of FIG. 11, to provide a flat surface for holding a portable electronic device, e.g., laptop computer.

In some example configurations, the attachment bracket 304 can include a flange 316 which can be a flared portion. For example, the bracket 304 can include a flange 316 on the upper surface of the rear edge of the bracket 304. The flange 316 can engage with a ridge on the upper brace, e.g., upper spanning brace 204 of FIG. 11, and prevent the work surface 112 from disengaging from the telescoping frame when the laptop tray is generally horizontal.

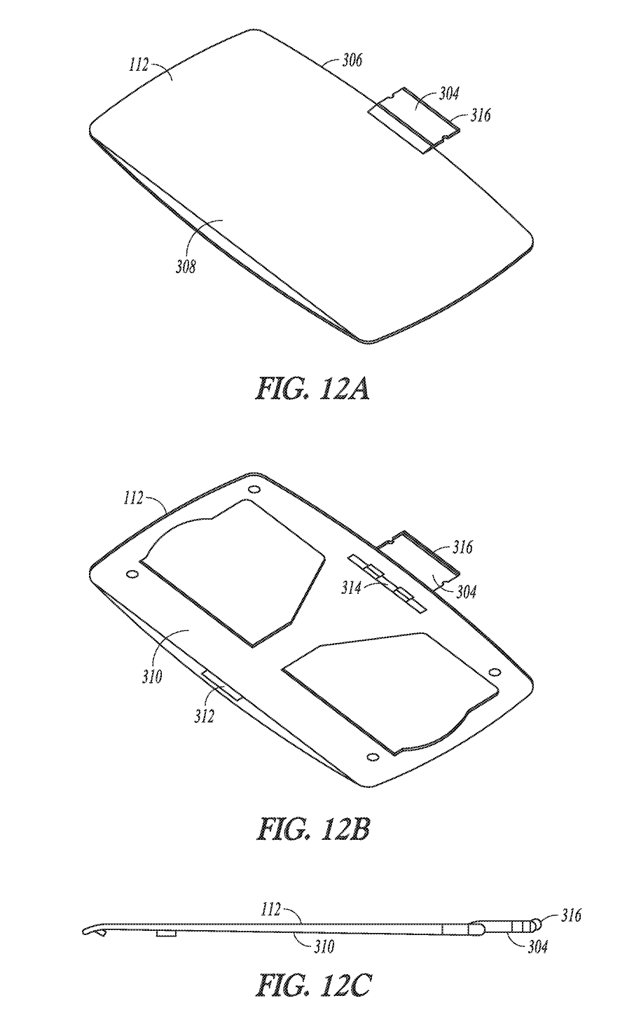

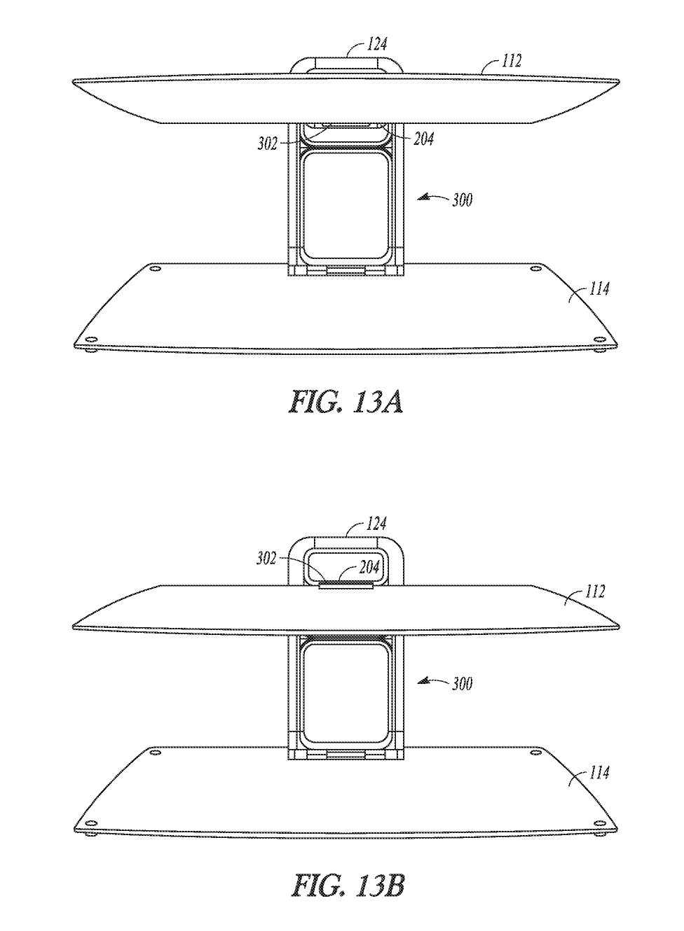

FIGS. 13A and 13B are perspective views depicting attachment of the work surface 112 of FIGS. 12A-12C to a telescoping frame of a height adjustable system for supporting a portable computing device. For conciseness, FIGS. 13A and 13B will be described together.

To attach the work surface 112, e.g., laptop tray, to the telescoping frame, e.g., telescoping frame 300 of FIG. 10, the user can angle the work surface 112 upwards and insert the attachment bracket 304 (shown in FIG. 11) into the slot 302 located in the upper spanning brace 204. After inserting the attachment bracket 304 into the slot 302, the user can tilt the work surface 112 downward into a horizontal position (FIG. 13B). In this horizontal position, the flange 316 (shown in FIG. 12C) located on the upper surface of the attachment bracket 304 can engage with a ridge (not depicted) inside the upper spanning brace 204. With the weight of the laptop tray and the weight of a laptop computer positioned on the tray, the work surface 112 is biased to tilt downwards, and as such, will not tilt up to disengage from the frame 300.

When the user wants to separate the work surface 112 from the frame 300 to stow it or to move it, the user can tilt the work surface 112 upward and separate it from the frame 300. After it is removed from the telescoping frame 300, the work surface 112 can also be used on a sitting person's lap to hold the laptop. The upper bridge 124 is shown and can be used as a handle during the work surface 112 installation process.

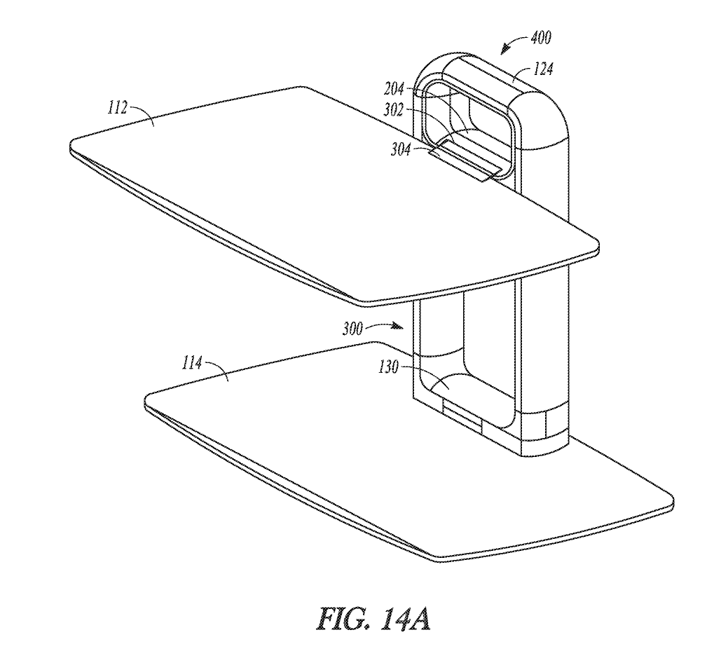

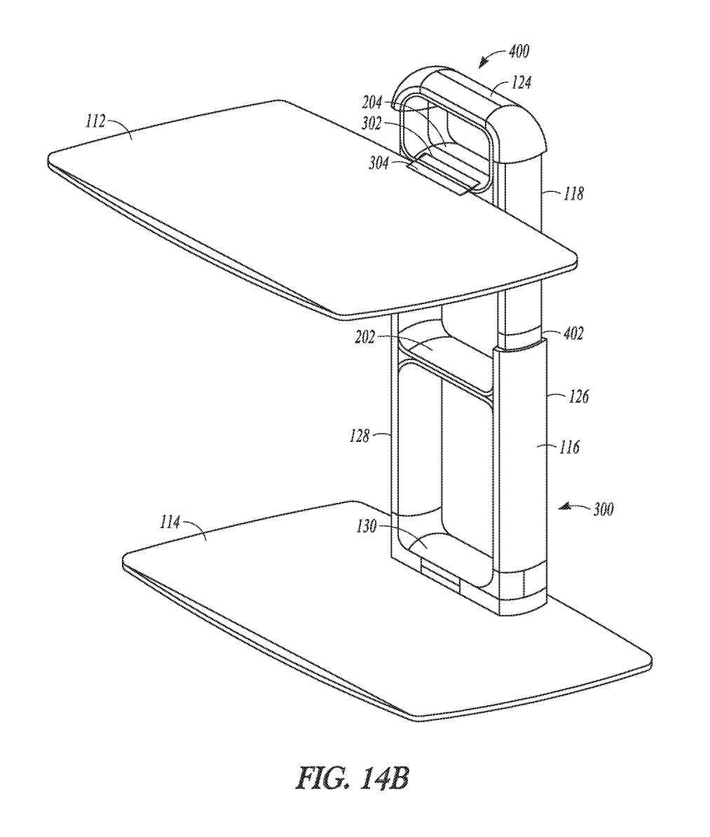

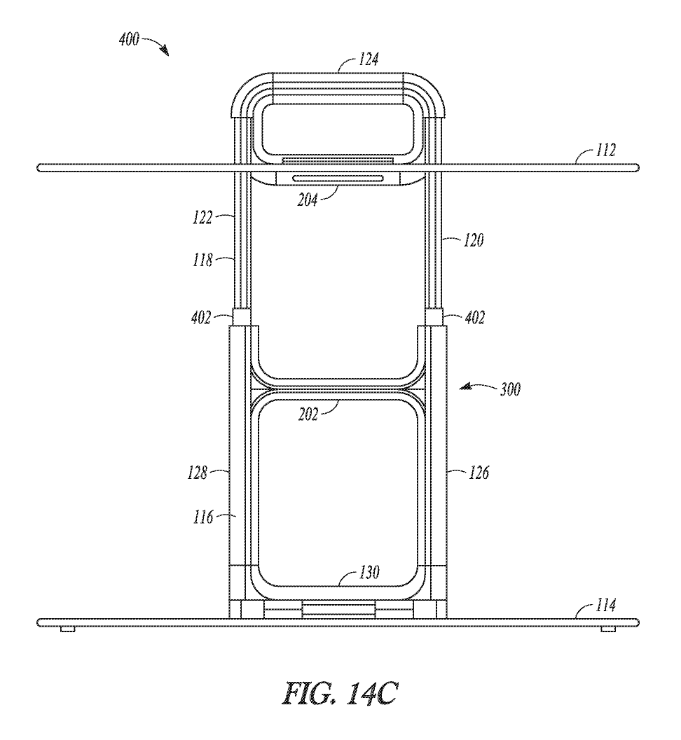

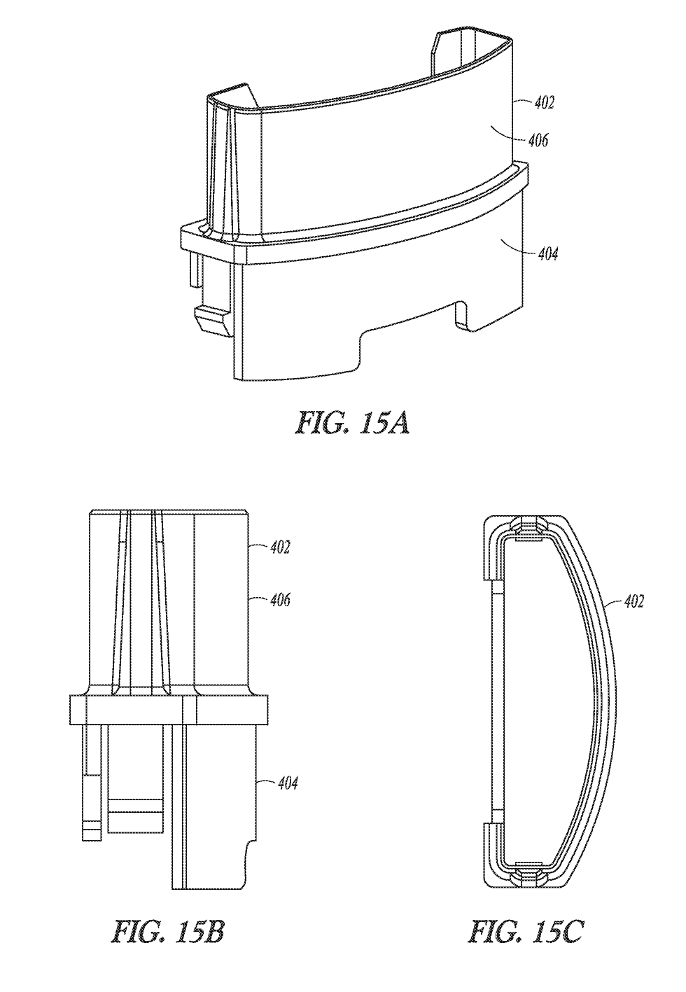

FIGS. 14A and 14B are front perspective views of an example height adjustable system for supporting a portable computing device, in accordance with this disclosure. FIG. 14C is a front view of the example height adjustable system of FIG. 14B. FIG. 14A depicts the system 400 in a contracted or compressed state and FIG. 14B depicts the system 400 in a raised or expanded state. As seen in FIGS. 14A and 14B, the attachment bracket 304 has been inserted into the slot 302 defined by the upper spanning brace 204. In FIGS. 14B and 14C, the movable portion 118 has been raised relative to the fixed portion 116. As shown and described in detail below with respect to FIGS. 15A-15C, in some examples, the system 400 can include guides 402 that can be sized and shaped to couple to first and second sides 126, 128 of the fixed portion 116. The guides 402 can be fixedly attached to the fixed portion proximate an upper end of each of the first and second sides 126, 128. The guides 402 can reduce or prevent the movable portion 118 from shaking during adjustment. The upper bridge 124, lower bridge 130, lower spanning brace 202, and base 114 are shown in FIGS. 14A-C.

FIGS. 15A-15C are various views of an example guide 402 that can be used in a height adjustable system, in accordance with this disclosure. FIG. 15A is a perspective view of the guide 402. FIG. 15B is a side view of the guide 402. FIG. 15C is a top view of the guide 402. For brevity, FIGS. 15A-15C will be described together.

In some examples, a cross-sectional profile of the guide 402 can be sized and shaped to mate with a cross-sectional profile of the fixed and movable portions of the telescoping frame, e.g., fixed and movable portions 116, 118 of frame 300 of FIG. 14C. For example, an external profile of a lower guide section 404 can be sized and shaped to mate with an internal cross-sectional profile of the fixed portion such that the lower guide section 404 is received by the inside of the fixed portion 116. In an example implementation, the guide 402 can be fixedly attached to the fixed portion of the telescoping frame over the lower guide section.

The upper guide section 406 of the guide 402 can be sized and shaped to slidingly engage with the external profile of the movable portion. As mentioned above, the guides 402 can reduce or prevent the movable portion 118 from shaking during adjustment and allow the movable portion to smoothly move up and down relative to the fixed portion of the frame.

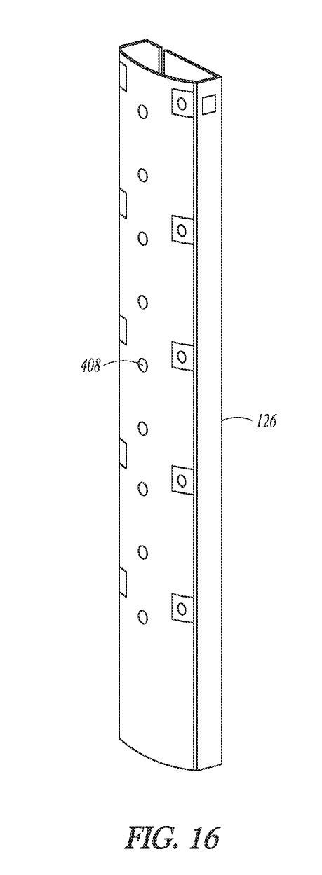

FIG. 16 is a front perspective view of an example side of a fixed portion of a telescoping frame. The side of FIG. 16, e.g., the first side 126 of fixed portion 116 of FIG. 14B, can be generally hollow. In some examples, the first side 126 of the fixed portion 116 can be made of sheet metal or die cast and can provide rigidity for the frame. In an example implementation, the side of the fixed portion can be covered with a cover, e.g., a plastic cover, for cosmetic purposes. The first side 126 can define a plurality of apertures 408 that can receive a portion of the movable portion and secure it at a desired height.

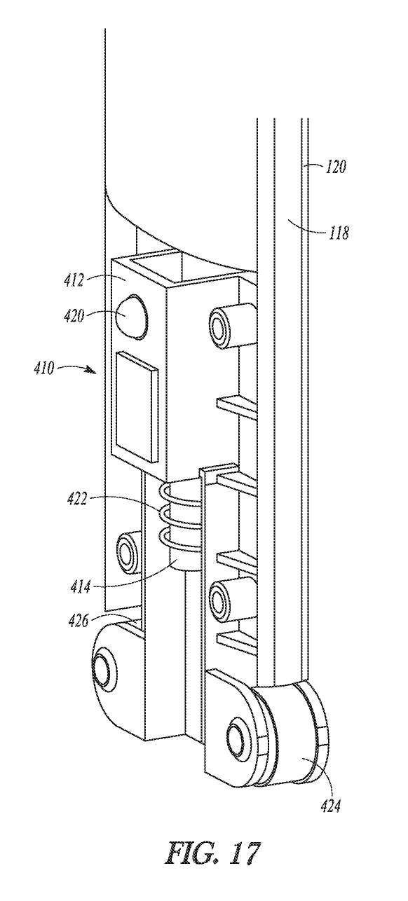

FIG. 17 is a front perspective view of an example side of a moving portion of a telescoping frame. The side of FIG. 17, e.g., first side 120 of moving portion 118 of telescoping frame 300 of FIG. 14C, can be generally hollow. In some examples, the first side 120 of the moving portion 118 can be made of sheet metal or die cast.

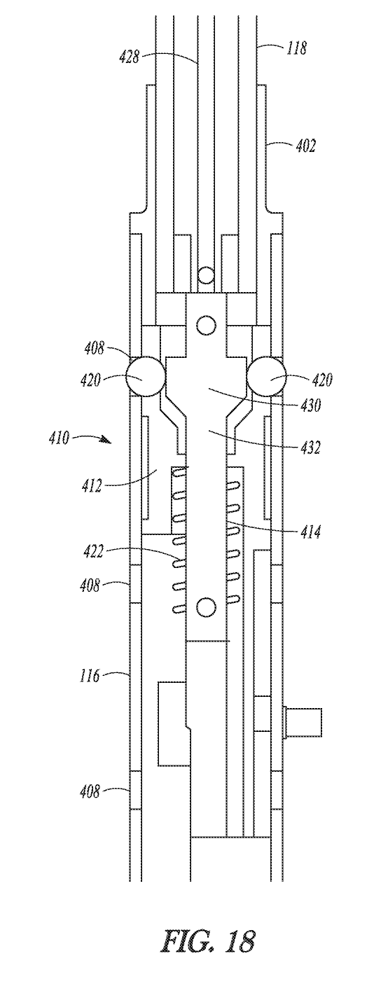

The example side shown in FIG. 17 can include a lock mechanism 410 including a lock housing 412 attached to the moving portion 118 proximate its lower end. The lock mechanism 410, which is described in more detail below with respect to FIG. 18, can further include a wedge 414, a compression spring 422 to bias the wedge 414, and at least one ball 420.

In addition, the moving portion 118 can include first and second rollers 424, 426 that can be attached to the lower end of the moving portion 118. The first and second rollers 424, 426 can roll on the inner surface of the fixed portion 116 of the telescoping frame, e.g., side 126 of fixed portion 116 of FIG. 16, and can provide additional support to guide the moving portion during a height adjustment.

FIG. 18 is a side cutaway view of an example side of a portion of a telescoping frame. More particularly, FIG. 18 depicts a lock mechanism 410 configured to lock the position of a moving portion of a telescoping frame, e.g., moving portion 118 of FIG. 14C, relative to a fixed portion of the telescoping frame, e.g., fixed portion 116 of FIG. 14C. The lock mechanism 410 can be located on one or both sides of the telescoping frame.

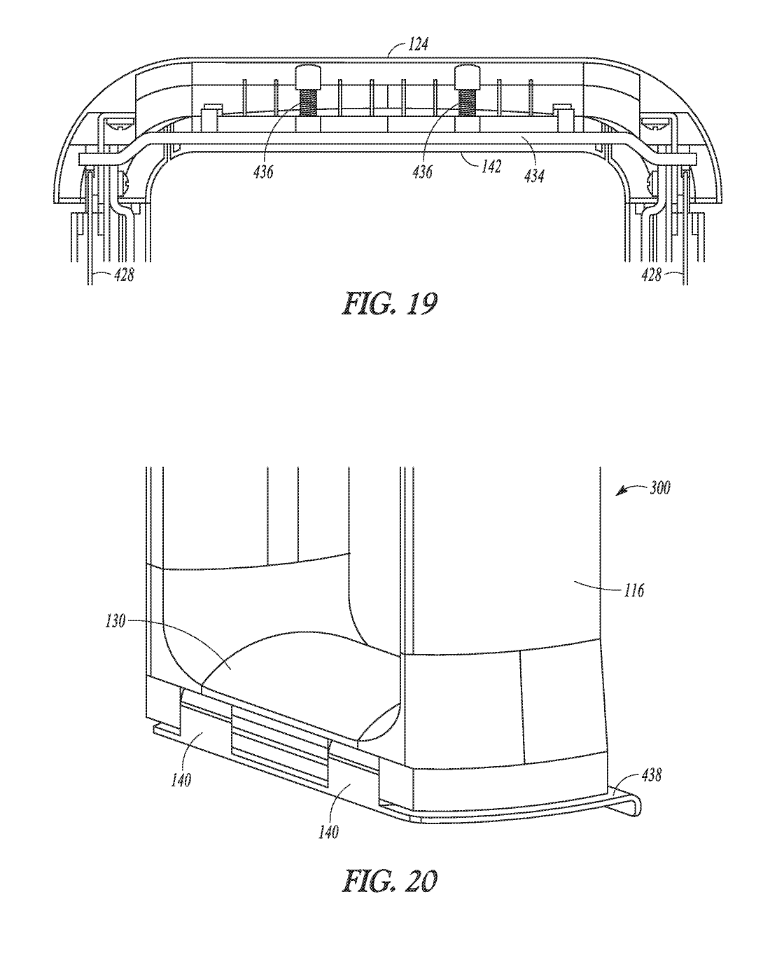

In FIG. 18, the lock housing 412 can be attached proximate the lower end of the moving portion 118. The lock housing 412 can guide the wedge 414 and balls 420. In the example configuration of FIG. 18, a vertical rod 428 extends from the upper end of the moving portion 118 (where it is attached to a horizontal bar or rod positioned in the upper bridge 124, as described below in FIG. 19) to the lower end of the moving portion 118 where it is attached to the wedge 414. The vertical rod 428 can include an elongated configuration.

The compression spring 422 can be located between the lock housing 412 and the wedge 414. The compression spring 422 can bias the wedge 414 downwards. When the wedge 414 moves downwards, the larger width 430 of the wedge 414 can align with the balls 420 and push them out into the apertures 408 located on the fixed portion 116 of the telescoping frame, e.g., apertures 408 of FIG. 16. When the user depresses the release button 142 (see FIGS. 6, 19) located at the underside of the upper bridge 124, e.g., release button 142 of FIG. 6 and FIG. 19, the vertical rod 428 can pull the wedge 414 upward and the smaller width 432 of the wedge 414 can align with the balls 420. This can allow the balls 420 to move into the gap between the lock housing 412 and the smaller width 432 of the wedge, which can release the interlock between the moving portion and the fixed portion and permit the height adjustment of the telescoping frame. When the user releases the release button 142, the compression spring 422 can push the wedge 414 downwards, which can align the larger width 430 of the wedge 414 with the balls 420 and push the balls 420 into the apertures 408 to lock the lock mechanism 410 and prevent further height adjustment.

FIG. 19 is a side cutaway view of an example upper bridge 124 of a telescoping frame. The example upper bridge 124 of FIG. 19 can include a release mechanism for a height adjustable telescoping frame, e.g., a release button 142, positioned at the underside of the upper bridge 124. In other example configurations, the release button 142 can be positioned on the top of the upper bridge or on a side of the upper bridge.

As mentioned above, the upper bridge 124 can include a horizontal bar 434 coupled to the upper ends of two vertical rods 428 (in configurations that have lock mechanisms 410 located on both sides of the telescoping frame) and coupled to the release mechanism, e.g., release button 142. When a user depresses the release button 142, the vertical rod 428 is pulled upward along with the wedge 414 of the lock mechanism 410 (shown in FIG. 18), thereby releasing the lock and allowing for height adjustment and repositioning of the laptop tray.

In some example configurations, the upper bridge 124 can also include one or more springs 436 coupled between the horizontal bar 434 and an inner surface of a top portion of the upper bridge 124. The one or more springs 436 can bias the horizontal bar 434 toward the underside of the upper bridge 124, which, in turn, biases the vertical rods 428 downward and keeps the balls 420 positioned within the apertures 408 to maintain the interlock between the fixed and moving portions of the telescoping frame.

FIG. 20 is a front perspective view of a lower portion of an example telescoping frame of a height adjustable system for supporting a portable computing device. For example, the portion shown in FIG. 20 can be a lower portion of the example telescoping frame 300 of the system 400 shown in FIGS. 14A-14C. In some examples, the telescoping frame can be coupled to a base. e.g., base 114 of FIG. 14C, using a base attachment bracket 438. In an example, the base attachment bracket 438 can be fixedly coupled to the base 114 and pivotably coupled to the lower bridge 130 using a pivot hub 140 (can be the same or similar to pivot 141 of FIG. 4). The pivot hub 140 that can allow the telescoping frame 300 to rotate relative to the base 114 about the pivot hub 140.

In some examples, the pivot hub 140 can be built into the lower bridge 130. In some examples, the pivot hub 140 can be formed into the base attachment bracket 438. In other example configurations, the pivot hub 140 can be manufactured as a separate component and connected to the base attachment bracket 438 during assembly of the telescoping frame 300. The pivot hub 140 allows the frame 300 to be tilted, e.g., tilted 90 degrees, and folded against the base 114 for storage and/or transport.

FIG. 21 is a rear perspective view of an example telescoping frame of a height adjustable system rotated relative to a base about a pivot hub, e.g., in a folded configuration for storage or transport. The base attachment bracket 438 can be fixedly attached, e.g., using screws, adhesives or other fasteners, to the base 114 at a rear edge 440 of the base 114.

As seen in FIG. 21, the telescoping frame 300 can be tilted forwards towards the front edge 442 of the base 114 and positioned against the top surface of the base 114. In other example configurations (not depicted), the telescoping frame 300 can be tilted backwards towards the rear edge 440 of the base 114, or rotated 180 degrees backwards and positioned against a bottom surface of the base 114.

In the example shown in FIG. 21, the base attachment bracket 438 can include a first latching mechanism and the lower bridge 130 can include a second latching mechanism configured to couple to the first latching mechanism. The second latching mechanism is described below with respect to FIG. 23.

The first latching mechanism can include one or more latch risers 446 that define respective latch riser apertures (shown in FIG. 22 at 450). The lower bridge housing 444 can define one or more apertures 448 sized and shaped to receive the one or more latch risers 446. The interaction between the base attachment bracket 438 and the lower bridge housing 444 is described in detail in FIGS. 22 and 23.

An axle (shown at 458 in FIG. 23) can be fixedly attached to the telescoping frame 300 inside the lower bridge 130 and can extend through the at least one pivot hub 140 and form the rotation axis for the telescoping frame 300.

When the telescoping frame 300 is in an upright orientation, the latch riser 446 can enter into the lower bridge housing 444 through the aperture 448 and engage the latch tab to secure the telescoping frame in the upright orientation, as explained below.

FIG. 22 is a perspective view of an example base attachment bracket, e.g., base attachment bracket 438 of FIG. 21. As mentioned above, the base attachment bracket 438 can include a first latching mechanism that can include one or more latch risers 446 that define respective latch riser apertures 450 sized and shaped to receive at least a portion of a latching tab (shown in FIG. 23 at 472). The latching tab 472 can engage the latch riser 446 via the latch riser aperture 450 to secure the telescoping frame, e.g., telescoping frame 300, in a vertical or upright orientation.

The base attachment bracket 438 can include one or more pivot hubs 140, as mentioned above. The one or more pivot hubs 140 and/or the one or more latch risers 446 can be integrally formed with the base attachment bracket 438, or the pivot hubs 140 and/or the latch risers 446 can be made separately and fixedly attached to the base attachment bracket 438.

The outer surface of the example pivot hub 140 shown in FIG. 22 can define a first detent 452, a second detent 454, and a cam surface 456. In an example configuration, the cam surface 456 can be formed between the first and second detent.

In some example implementations, the first detent 452 and the second detent 454 can be formed on the outer surface about 90 degrees from one another. The first detent 452 and the second detent 454 can help maintain the telescoping frame, e.g., telescoping frame 300, in an upright, e.g., vertical, or folded, e.g., horizontal, orientations relative to the base attachment bracket 438.

FIG. 23 is a perspective view of an example lower bridge housing, e.g., lower bridge housing 444 of FIG. 21, coupled to the base attachment bracket of FIG. 22. More particularly, FIG. 23 depicts an internal view of the lower bridge housing 444 when the telescoping frame is in an upright or vertical orientation.

The lower bridge housing 444 can include an axle 458 extending through the axle apertures (shown at 460 in FIG. 22) defined by the pivot hubs 140 of the base attachment bracket 438. The lower bridge housing can also include one or more cam follower mechanisms 462 that can include a cam follower 464 coupled to a first compression spring 466 coupled to a cam follower housing 468.

As mentioned above, the lower bridge 130 can include a second latching mechanism 470 configured to couple to the first latching mechanism (e.g., the one or more latch risers 446 that define respective latch riser apertures 450. The second latching mechanism 470 can include a latching tab 472 sized and shaped to extend through the latch riser aperture 450 of a latch riser 446. e.g., the first latching mechanism, which can secure the position of the lower bridge housing 444, and thus the telescoping frame, relative to the base attachment bracket 438.

The lower bridge housing 444 can include a tilt release tab 474 (also referred to as a latch release tab) coupled to the second latching mechanism 470, e.g., the latching tab 472. The latch release tab 474 can be configured to decouple the first latching mechanism. e.g., the latch riser 446, and the second latching mechanism, e.g., the latching tab 472, when depressed. More particularly, when the latch release tab 474 is depressed, the latching tab 472 is drawn out of the latch riser aperture 450 of the latch riser 446, thereby allowing the lower bridge housing 444 to pivot relative to the base attachment bracket 438. The latch release tab 474 can include a spring (not depicted) to bias the latching tab 472. In an example, the tilt release tab 474 can be slidingly engaged with the lower bridge housing 444 and can be guided inside the housing 444 using one or more flanges 445.

The cam follower mechanism 462 can allow the lower bridge housing 444 to smoothly pivot relative to the base attachment bracket 438 from an upright orientation into a stored orientation. As seen in FIG. 23, the first compression spring 466 biases the cam follower 464 against outer surface of the pivot hub 140, namely the first detent 452. After the latch release tab 474 is depressed, the telescoping frame can be pivoted about the axle 452 into a stored orientation, which results in the cam follower 464 exiting the first detent 452, riding along outer surface of the pivot hub 140 and entering the second detent 454.

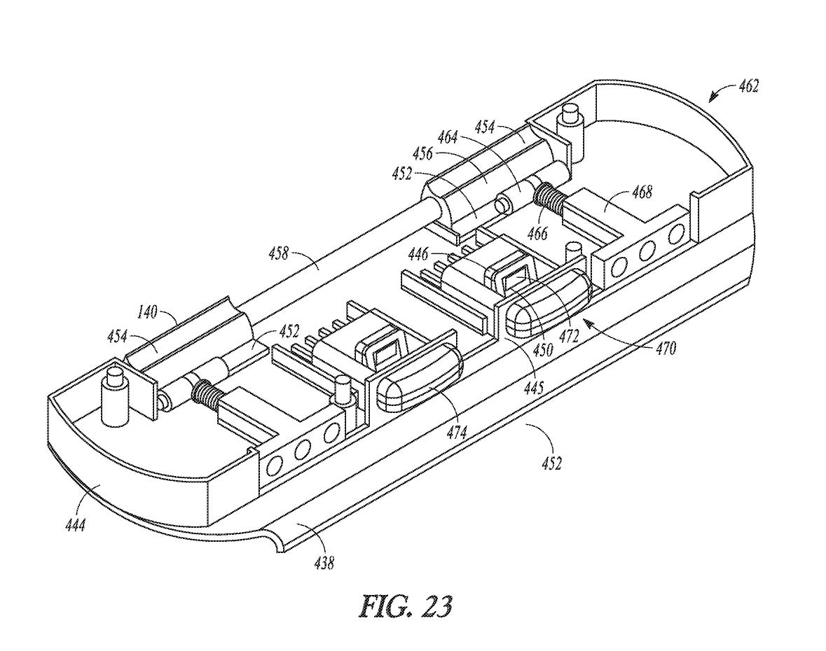

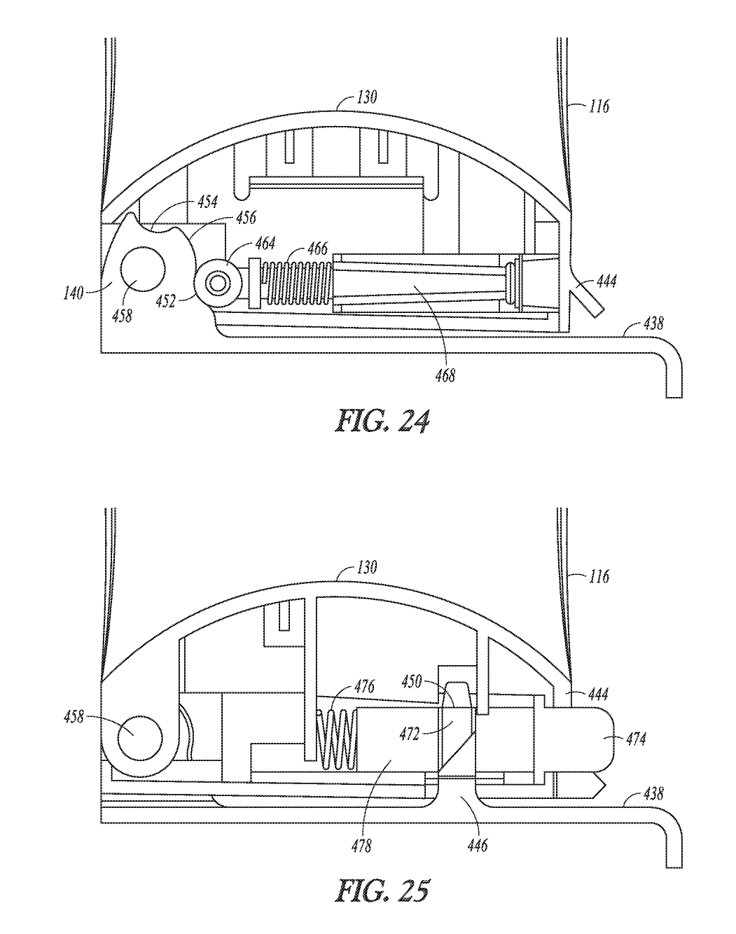

FIG. 24 is cross-sectional side view of an example cam follower mechanism of a telescoping frame. The telescoping frame, e.g., telescoping frame 300 of FIG. 14C, is an upright, e.g., generally vertical, orientation.

In some examples, the cam follower housing 468 can be fixedly attached to the lower bridge housing 444 and the cam follower 464 can slidingly engage with the cam follower housing 468. The first compression spring 466, which can bias the cam follower 464 against the cam surface 456, can be positioned between the cam follower 464 and the cam follower housing 468.

When in the upright orientation, the first compression spring 466 biases the cam follower 464 against the cam surface 456 and, in particular, against the first detent 452. When a user depresses the latch release tab (shown at 474 in FIG. 23), the telescoping frame can pivot about the axle 458 into a stored orientation against the base (not shown). When pivoting, the first compression spring 466 can bias the cam follower 464 against the cam surface 456 until the cam follower 464 enters the second detent 454, thereby releasably securing the telescoping frame in the stored orientation, e.g., generally parallel to the base 114.

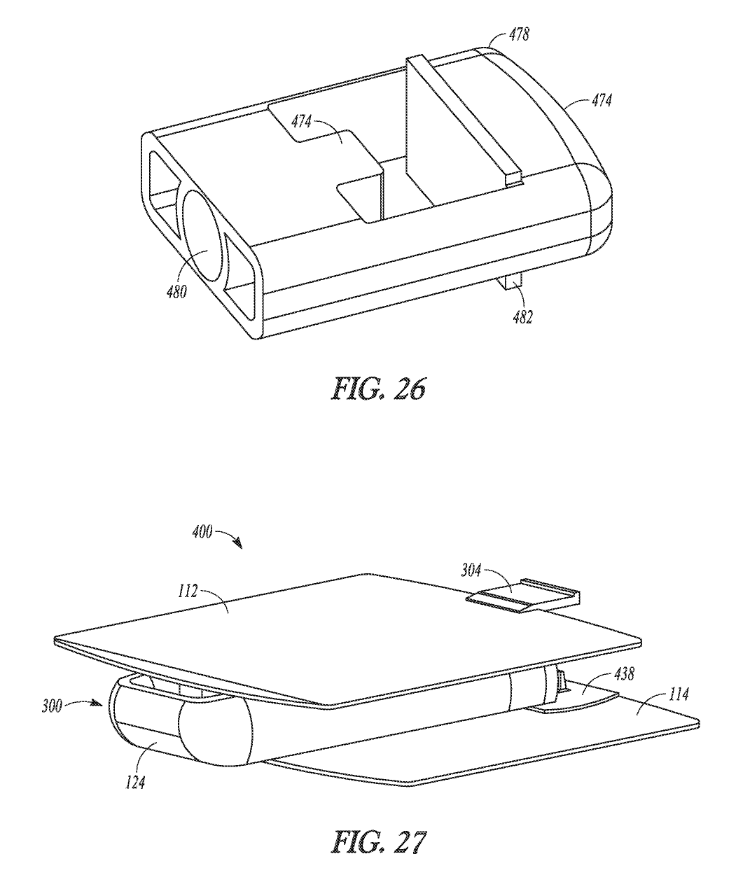

FIG. 25 is cross-sectional side view of an example tilt latch mechanism of a telescoping frame. In the example shown, the tilt release tab 474 is slidingly engaged with the lower bridge housing 444 and can be guided inside the housing 444 using one or more flanges 445 (shown in FIG. 23) that are formed into the housing 444. The tilt latch mechanism can include a second compression spring 476 located between a latching tab 472 extending from the lower bridge housing 444 and the tilt latch body 478. In some examples, the tilt release tab 474 and the latching tab 472 can be formed as part of the tilt latch body 478, as shown in FIG. 26.

The second compression spring can bias the tilt latch body 478 in the rearwards direction (towards the axle) in a latched position. In the latched position, e.g., when the telescoping frame is in an upright orientation, the latching tab 472 can be inserted into the aperture 450 defined by the latch riser 446. In this position, the tilt release tab 474 can be exposed outside the lower bridge housing 444. The user can then push the tilt release tab 474, which causes the latching tab 472 to disengage from the aperture 450 of the latch riser 446, thereby allowing the telescoping frame to pivot or tilt. The lower bridge 130 and fixed portion 116 are shown.

FIG. 26 is a perspective view of an example tilt latch body. The tilt latch body 478 can include the tilt release tab 474, the latching tab 472, and a flange 482 sized and shaped to abut against a corresponding flange of the lower bridge housing. e.g., flange 445 of FIG. 23, in an extended position. The latching tab 472, which can be hook-shaped in some examples, is sized and shaped to extend through the aperture 450 of the latch riser (shown in FIG. 25) and releasably secure the latching tab 472 to the riser. The tilt latch body 478 can define a housing 480 for receiving at least a portion of the second compression spring 476 (shown in FIG. 25).

FIG. 27 is a perspective view of an example height adjustable system for supporting a portable computing device, in a stored configuration. As seen in FIG. 27, the telescoping frame, e.g., telescoping frame 300 of FIG. 14C, has been pivoted and is generally parallel with the base 114. The attachment bracket 304 for the laptop tray has been removed from the telescoping frame 300, e.g., from the slot 302 of FIG. 14B, and the laptop tray has been releasably secured to the telescoping frame 300 using the first and second notches 312, 314 of the laptop tray (shown in FIG. 12B) and the tabs 208 (shown in FIGS. 8 and 9) and tilt release tabs 474 (shown in FIG. 23).

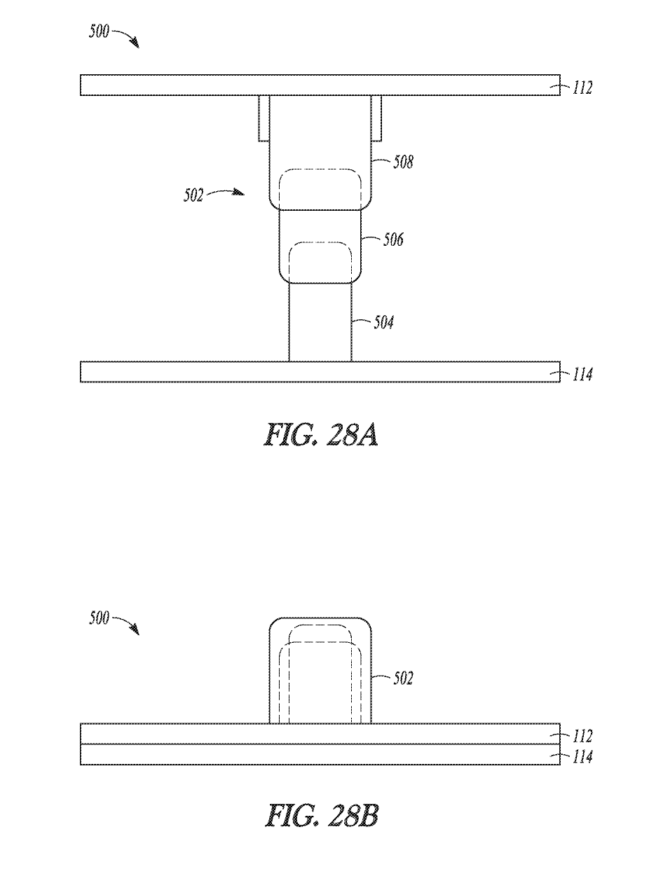

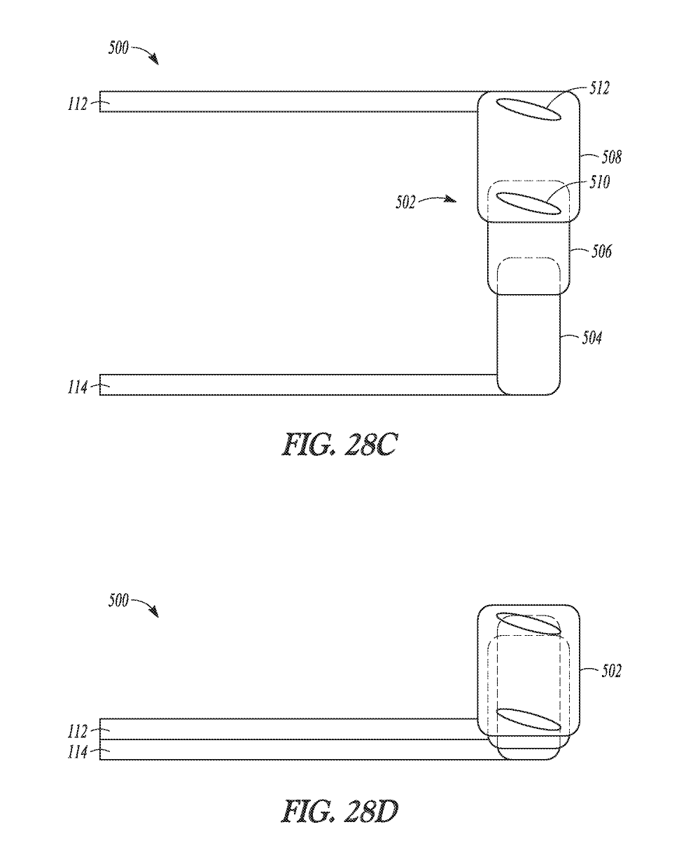

FIG. 28A is a front view of another example of a height adjustable system for supporting a portable computing device, in an expanded configuration. FIG. 28B is a front view of the system of FIG. 28A in a collapsed configuration. FIG. 28C is a side view of the system of FIG. 28A. FIG. 28D is a side view of the system of FIG. 28B. For brevity, FIGS. 28A-28D will be described together.

The system 500 can include a telescoping beam 502 (or column) coupled between a base 114 and a work surface 112, as seen in FIGS. 28A and 28C. In the collapsed configuration of FIGS. 28B and 28D, the work surface 112 can be detached from the telescoping beam 502 and then paired with the base 114, e.g., such that the work surface 112 rests on the base 114. The telescoping beam 502 can include multiple interconnected sections, such as sections 504, 506, and 508.

As seen in FIGS. 28C and 28D, the telescoping beam 502 can be positioned between rear edges of the work surface 112 and the base 114. The telescoping beam 502 can include a first interconnect that can include a first pair of hooks or notches defined by a section of the telescoping beam 502, e.g., section 508, and configured to receive the work surface 112 at a first height, and a second interconnect that can include a second pair of hooks or notches defined by the same or another section of the telescoping beam 502, e.g., section 508, and configured to receive the work surface 112 at a second height. As seen in FIG. 28C, the section 508 can include first interconnects 510, e.g., on each side of the section 508, where the pair of first interconnects form the first pair of hooks. The section 508, or another section, can include second interconnects 512, e.g., on each side of the section 508 or another section, where the pair of second interconnects form the second pair of hooks.

The telescoping system described above can allow a user to adjust the height of a portable electronic device conveniently and intuitively. The telescoping feature of the frame can allow the unit to be compact, which can improve visual appeal and limit overuse of the surrounding environment. Additionally, the telescoping feature can improve rigidity of vertical structural members.

The laptop tray/work surface can be lightweight and easily removable, thereby allowing it to be used in other areas of an environment at which the user may sit. In addition, the ability of the telescoping frame to pivot and fold makes the unit more portable and storable.

The design of the systems described can be more affordable to manufacture than other designs, such as designs that include 4-bar stabilization techniques, which can ultimately benefit consumers.

### Additional Notes and Examples

In Example 1, a height adjustable system can include subject matter (such as a system or apparatus) comprising: a work surface; a telescoping frame, the telescoping frame including: a movable portion configured to couple to the work surface, the movable portion including: a first side; a second side; an upper bridge extending between the first side of the movable portion and the second side of the movable portion; a fixed portion including: a first side; a second side; a lower bridge extending between the first side of the fixed portion and the second side of the fixed portion, the first side of the fixed portion configured to receive at least a portion of the first side of the movable portion, the second side of the fixed portion configured to receive at least a portion of the second side of the movable portion; a base configured to couple to and support the telescoping frame; a locking mechanism configured to releasably fix the position of the movable portion relative to the fixed portion; and a release mechanism coupled to and configured to control the locking mechanism.

In Example 2, the system of Example 1 can optionally be configured to further comprise a base attachment bracket fixedly coupled to the base and pivotably coupled to the lower bridge.

In Example 3, the system of Example 2 can optionally be configured such that the base attachment bracket includes a first latching mechanism, and wherein the lower bridge includes a second latching mechanism configured to releasably couple to the first latching mechanism.

In Example 4, the system of Example 3 can optionally be configured such that the lower bridge includes a latch release tab coupled to the second latching mechanism, the latch release tab configured to decouple the first latching mechanism and the second latching mechanism when depressed.

In Example 5, the system of any one or any combination of Examples 3-4 can optionally be configured such that the second latching mechanism includes a latching tab, and wherein the first latching mechanism includes at least one latch riser defining a latch riser aperture configured to receive at least a portion of the latching tab.

In Example 6, the system of any one or any combination of Examples 1-5 can optionally be configured such that the movable portion includes at least one first interconnect configured to connect the work surface to the frame at a first height.

In Example 7, the system of Example 6 can optionally be configured such that the fixed portion includes at least one second interconnect configured to connect the work surface to the frame at a second height lower than the first height.

In Example 8, the system of Example 7 can optionally be configured such that the at least one first interconnect comprises a first pair of hooks defined by the movable portion and configured to receive the work surface at the first height, and the at least one second interconnect comprises a second pair of hooks defined by the fixed portion and configured to receive the work surface at the second height.

In Example 9, the system of any one or any combination of Examples 7-8 can optionally be configured such that the at least one first interconnect defines a slot, and wherein the work surface includes an attachment bracket, the system comprising: an upper brace extending between the first side of the movable portion and the second side of the movable portion, the upper brace defining the slot configured to receive the work surface attachment bracket.

In Example 10, the system of Example 9 can optionally be configured to further comprise a lower brace extending between the first side of the fixed portion and the second side of the fixed portion.

In Example 11, the system of any one or any combination of Examples 1-10 can optionally be configured such that the release mechanism comprises a release button, and wherein the upper bridge includes the release button.

In Example 12, the system of any one or any combination of Examples 1-11 can optionally be configured to further comprise a first guide member and a second guide member, wherein the first side of the fixed portion includes an upper portion fixedly engaged to the first guide member, wherein the second side of the fixed portion includes an upper portion fixedly engaged to the second guide member, and wherein the first guide member and the second guide member are slidably engaged to the movable portion.

In Example 13, a height adjustable system can includes subject matter (such as a system or apparatus) comprising: a work surface; a telescoping frame, the telescoping frame including: a movable portion configured to couple to the work surface, the movable portion including: a first side; a second side; an upper bridge extending between the first side of the movable portion and the second side of the movable portion; a fixed portion including: a first side; a second side; a lower bridge extending between the first side of the fixed portion and the second side of the fixed portion, the lower bridge including a first latching mechanism, the first side of the fixed portion configured to receive at least a portion of the first side of the movable portion, the second side of the fixed portion configured to receive at least a portion of the second side of the movable portion; a base configured to couple to and support the telescoping frame; a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base; a locking mechanism configured to releasably fix the position of the movable portion relative to the fixed portion; and a release mechanism coupled to and configured to control the locking mechanism.

In Example 14, the system of Example 13 can optionally be configured such that the lower bridge includes a latch release tab coupled to the first latching mechanism, the latch release tab configured to decouple the first latching mechanism and the second latching mechanism when depressed.

In Example 15, the system of any one or any combination of Examples 13-14 can optionally be configured such that the first latching mechanism includes a latching tab, and wherein the second latching mechanism includes at least one latch riser defining a latch riser aperture configured to receive at least a portion of the latching tab.

In Example 16, the system of any one or any combination of Examples 13-15 can optionally be configured such that the movable portion includes at least one first interconnect configured to connect the work surface to the frame at a first height, and wherein the fixed portion includes at least one second interconnect configured to connect the work surface to the frame at a second height lower than the first height.

In Example 17, the system of Example 16 can optionally be configured such that the at least one first interconnect comprises a first pair of hooks defined by the movable portion and configured to receive the work surface at the first height, and the at least one second interconnect comprises a second pair of hooks defined by the fixed portion and configured to receive the work surface at the second height.

In Example 18, the system of any one or any combination of Examples 13-17 can optionally be configured such that the movable portion defines a slot, and wherein the work surface includes an attachment bracket, the system comprising: an upper brace extending between the first side of the movable portion and the second side of the movable portion, the upper brace defining the slot configured to receive the work surface attachment bracket.

In Example 19, the system of any one or any combination of Examples 13-18 can optionally be configured to further comprise a first guide member and a second guide member, wherein the first side of the fixed portion includes an upper portion fixedly engaged to the first guide member, wherein the second side of the fixed portion includes an upper portion fixedly engaged to the second guide member, and wherein the first guide member and the second guide member are slidably engaged to the movable portion.

In Example 20, a height adjustable system can includes subject matter (such as a system or apparatus) comprising: a work surface including a work surface attachment bracket; a telescoping frame, the telescoping frame including: a movable portion configured to couple to the work surface, the movable portion including: a first side; a second side; an upper bridge extending between the first side of the movable portion and the second side of the movable portion; an upper brace extending between the first side of the movable portion and the second side of the movable portion, the upper brace defining a configured to receive the work surface attachment bracket; a fixed portion including: a first side; a second side; a lower bridge extending between the first side of the fixed portion and the second side of the fixed portion, the lower bridge including a first latching mechanism, the first side of the fixed portion configured to receive at least a portion of the first side of the movable portion, the second side of the fixed portion configured to receive at least a portion of the second side of the movable portion; a base configured to couple to and support the telescoping frame; a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base; a locking mechanism configured to releasably fix the position of the movable portion relative to the fixed portion; and a release mechanism coupled to and configured to control the locking mechanism.

In Example 21, a height adjustable systems of any one or any combination of Examples 1-20 can optionally be configured such that all elements, operations, or other options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

1. A height adjustable system for supporting a portable computing device, comprising:
a work surface;
a telescoping frame, the telescoping frame including:
a movable portion configured to couple to the work surface, the movable portion including:
a first side;
a second side;
an upper bridge extending between the first side of the movable portion and the second side of the movable portion;
a fixed portion including:
a first side;
a second side;
a lower bridge extending between the first side of the fixed portion and the second side of the fixed portion,
the first side of the fixed portion configured to receive at least a portion of the first side of the movable portion,
the second side of the fixed portion configured to receive at least a portion of the second side of the movable portion;
a base configured to couple to and support the telescoping frame;
a locking mechanism configured to releasably fix a position of the movable portion relative to the fixed portion; and
a release mechanism coupled to and configured to control the locking mechanism.

2. The system of claim 1, comprising:
a base attachment bracket fixedly coupled to the base and pivotably coupled to the lower bridge.

3. The system of claim 2, wherein the base attachment bracket includes a first latching mechanism, and wherein the lower bridge includes a second latching mechanism configured to releasably couple to the first latching mechanism.

4. The system of claim 3, wherein the lower bridge includes a latch release tab coupled to the second latching mechanism, the latch release tab configured to decouple the first latching mechanism and the second latching mechanism when depressed.

5. The system of claim 3, wherein the second latching mechanism includes a latching tab, and wherein the first latching mechanism includes at least one latch riser defining a latch riser aperture configured to receive at least a portion of the latching tab.

6. The system of claim 1, wherein the movable portion includes at least one first interconnect configured to connect the work surface to the telescoping frame at a first height.

7. The system of claim 6, wherein the fixed portion includes at least one second interconnect configured to connect the work surface to the telescoping frame at a second height lower than the first height.

8. The system of claim 7, wherein the at least one first interconnect comprises a first pair of hooks defined by the movable portion and configured to receive the work surface at the first height, and the at least one second interconnect comprises a second pair of hooks defined by the fixed portion and configured to receive the work surface at the second height.

9. The system of claim 7, wherein the at least one first interconnect defines a slot, and wherein the work surface includes an attachment bracket, the system comprising:
an upper brace extending between the first side of the movable portion and the second side of the movable portion, the upper brace defining the slot configured to receive the attachment bracket.

10. The system of claim 9, comprising:
a lower brace extending between the first side of the fixed portion and the second side of the fixed portion.

11. The system of claim 1, wherein the release mechanism comprises a release button, and wherein the upper bridge includes the release button.

12. The system of claim 1, comprising:
a first guide member and a second guide member,
wherein the first side of the fixed portion includes an upper portion fixedly engaged to the first guide member,
wherein the second side of the fixed portion includes an upper portion fixedly engaged to the second guide member, and
wherein the first guide member and the second guide member are slidably engaged to the movable portion.

13. A height adjustable system for supporting a portable computing device, comprising:
a work surface;
a telescoping frame, the telescoping frame including:
a movable portion configured to couple to the work surface, the movable portion including:
a first side;
a second side;
an upper bridge extending between the first side of the movable portion and the second side of the movable portion;
a fixed portion including:
a first side;
a second side;
a lower bridge extending between the first side of the fixed portion and the second side of the fixed portion, the lower bridge including a first latching mechanism,
the first side of the fixed portion configured to receive at least a portion of the first side of the movable portion,
the second side of the fixed portion configured to receive at least a portion of the second side of the movable portion;
a base configured to couple to and support the telescoping frame;
a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base;
a locking mechanism configured to releasably fix the position of the movable portion relative to the fixed portion; and
a release mechanism coupled to and configured to control the locking mechanism.

14. The system of claim 13, wherein the lower bridge includes a latch release tab coupled to the first latching mechanism, the latch release tab configured to decouple the first latching mechanism and the second latching mechanism when depressed.

15. The system of claim 13, wherein the first latching mechanism includes a latching tab, and wherein the second latching mechanism includes at least one latch riser defining a latch riser aperture configured to receive at least a portion of the latching tab.

16. The system of claim 13, wherein the movable portion includes at least one first interconnect configured to connect the work surface to the frame at a first height, and wherein the fixed portion includes at least one second interconnect configured to connect the work surface to the frame at a second height lower than the first height.

17. The system of claim 16, wherein the at least one first interconnect comprises a first pair of hooks defined by the movable portion and configured to receive the work surface at the first height, and the at least one second interconnect comprises a second pair of hooks defined by the fixed portion and configured to receive the work surface at the second height.

18. The system of claim 13, wherein the movable portion defines a slot, and wherein the work surface includes an attachment bracket, the system comprising:
an upper brace extending between the first side of the movable portion and the second side of the movable portion, the upper brace defining the slot configured to receive the attachment bracket.

19. The system of claim 13, comprising:
a first guide member and a second guide member,
wherein the first side of the fixed portion includes an upper portion fixedly engaged to the first guide member,
wherein the second side of the fixed portion includes an upper portion fixedly engaged to the second guide member, and
wherein the first guide member and the second guide member are slidably engaged to the movable portion.

20. A height adjustable system for supporting a portable computing device, comprising:
a work surface including a work surface attachment bracket;
a telescoping frame, the telescoping frame including:
a movable portion configured to couple to the work surface, the movable portion including:
a first side;
a second side;
an upper bridge extending between the first side of the movable portion and the second side of the movable portion;
an upper brace extending between the first side of the movable portion and the second side of the movable portion, the upper brace defining a configured to receive the work surface attachment bracket;
a fixed portion including:
a first side;
a second side;
a lower bridge extending between the first side of the fixed portion and the second side of the fixed portion, the lower bridge including a first latching mechanism,
the first side of the fixed portion configured to receive at least a portion of the first side of the movable portion,
the second side of the fixed portion configured to receive at least a portion of the second side of the movable portion;
a base configured to couple to and support the telescoping frame;
a base attachment bracket fixedly coupled to the base and pivotably coupled to the lower bridge, the base attachment bracket including a second latching mechanism configured to releasably couple to the first latching mechanism, the base attachment bracket and the lower bridge being so configured as to allow the telescoping frame to pivot between a position generally parallel to the base and a position generally perpendicular to the base;
a locking mechanism configured to releasably fix the position of the movable portion relative to the fixed portion; and
a release mechanism coupled to and configured to control the locking mechanism.
